(19) United States
(12) Patent Application Publication
(10) Pub. No.: US 2020/0216342 A1
(43) Pub. Date: Jul. 9, 2020

(54) PORTABLE WATER TREATMENT SYSTEM USING OZONE

(71) Applicant: Clean Team Holdings Inc., Pasadena, CA (US)

(72) Inventors: Alejandro Islas, San Gabriel, CA (US); William Lance Burrows, Big Bear Lake, CA (US)

(21) Appl. No.: 16/737,791

(22) Filed: Jan. 8, 2020

Related U.S. Application Data
(60) Provisional application No. 62/789,956, filed on Jan. 8, 2019.

(51) Int. Cl. C02F 1/78; C02F 1/00

(52) U.S. Cl. CPC C02F 1/78; C02F 2303/04; C02F 2301/04; C02F 1/002

(57) ABSTRACT

A portable water treatment system using ozone is disclosed. The portable water treatment system includes a collapsible container for holding water; a removable cover on an open end of the collapsible container, the removable cover having an opening configured to receive the water into the collapsible container; a filter positioned at the opening of the removable cover and configured to filter the water entering the collapsible container; and a water treatment device configured to disinfect the water in the collapsible container using ozone, the water treatment device comprising a tortuous porous tube configured to distribute the ozone.

### PRIORITY CLAIM

This application claims priority to and the benefit of U.S. provisional patent application No. 62/789,956 filed in the United States Patent and Trademark Office on Jan. 8, 2019, the entire content of which is incorporated herein by reference as if fully set forth below in its entirety and for all applicable purposes.

### INTRODUCTION

The present invention relates to a portable water treatment system. More particularly, it relates to a portable water treatment system that is arranged to be easily carried and operated to treat water using ozone.

When people travel through foreign regions or remote areas, the travelers often have no reliable access to clean and safe drinking water. Even when municipal or other water systems are available, the water may not be suitable for direct consumption without further treatments like disinfecting and filtering. In some examples, disinfectant like iodine-containing tablets may be dissolved in water for disinfecting the water. While iodine water treatment or the like can remove certain potential pathogens from the water, such treated water may be discolored and foul-smelling. Moreover, impurities like dirt and sediment may still be present in the water.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the present disclosure provide a portable water treatment system using ozone. The portable water treatment system includes a collapsible container for holding water; a removable cover on an open end of the collapsible container, the removable cover having an opening configured to receive the water into the collapsible container; a filter positioned at the opening of the removable cover and configured to filter the water entering the collapsible container; and a water treatment device configured to disinfect the water in the collapsible container using ozone, the water treatment device comprising a tortuous porous tube configured to distribute the ozone.

In some aspects, the portable water treatment system may further include an ozone supply configured to supply the ozone to the water treatment device. In some aspects, the filter may include a sheet filter. In some aspects, the sheet filter may include a paper filter or cloth filter. In some aspects, the sheet filter may have a size configured to cover the entire open end of the collapsible container. In some aspects, the sheet filter may be configured to wrap around an edge of the open end of the collapsible container. In some aspects, the filter is removably secured between the removable cover and the collapsible container. In some aspects, the tortuous porous tube may be configured in at least one of: a coiled shape; a helical shape; a spiral shape; a circular shape; or a wound shape. In some aspects, the tortuous porous tube when extended may be substantially longer than the water treatment device in a length and/or width direction.

### BRIEF DESCRIPTION OF THE DRAWINGS

FIGS. 1 and 2 are conceptual diagrams illustrating a portable water treatment system using ozone according to one embodiment.

FIG. 3 is a conceptual diagram illustrating an ozone supply according to one embodiment.

FIGS. 4 and 5 are diagrams illustrating a top view and a perspective view of a water treatment device according to one embodiment.

### DETAILED DESCRIPTION

Referring now to the drawings, embodiments of systems and methods of a portable water treatment system using ozone as a sterilant or disinfectant are disclosed in the present disclosure. The sizes and shapes of the various features, components, devices, and apparatuses shown in the drawings are illustrative in nature and not limiting.

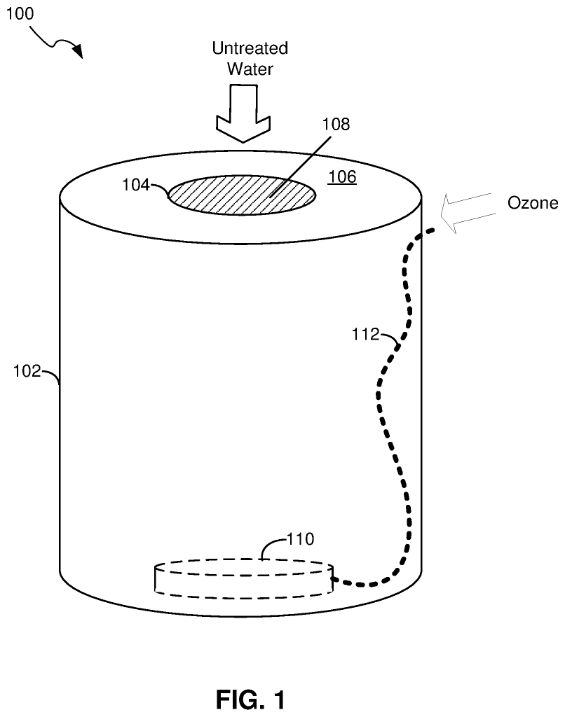

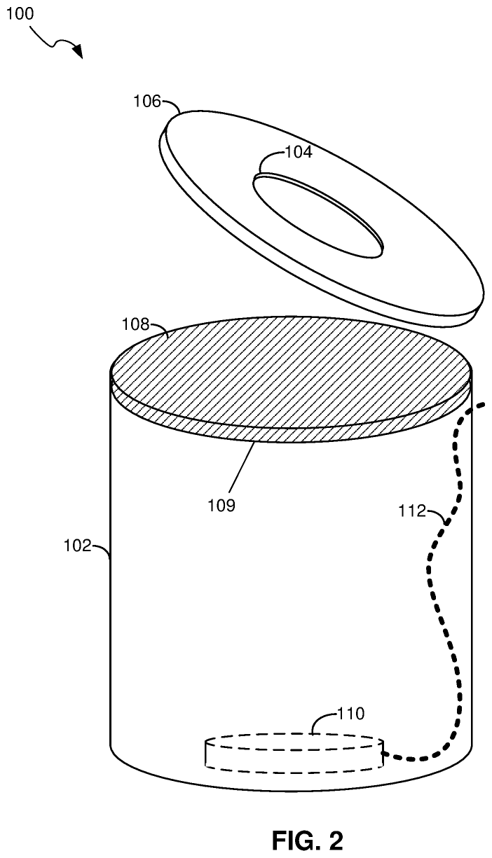

FIG. 1 is a conceptual diagram illustrating a portable water treatment system 100 using ozone according to one embodiment. The portable water treatment system 100 includes a collapsible container 102 for holding water or any desired fluid. The collapsible container 102 may be made of any suitable flexible material, for example, plastic, rubber, or waterproof fabric such that the collapsible container 102 may be folded and/or compressed into a compact size for easy storage and travel. When the collapsible container 102 is set in an expanded configuration (shown in FIGS. 1 and 2), it can be used to store water. Untreated water may be introduced into the container 102 via an opening 104 on a cover 106. A filter 108 may be positioned at the opening 104 to filter the water entering the container 102. In some embodiments, the filter 108 is configured to filter sediments, undesirable chemicals, biological contaminants, and/or suspended solids from the water. In some examples, the filter 108 may be a paper filter, a cloth filter, etc.

FIG. 2 is a perspective view of the portable water treatment system 100 with the cover 106 separated from the container 102. In one embodiment, the filter 108 may be sized to cover the entire open end of the container 102. In some examples, the filter 108 may be a sheet filter that has a size and diameter larger than the open end of the container 102. The filter 108 is installed on the container 102, then the cover 106 is installed on the container 102 with the filter 108 secured between the cover 106 and the container 102. In some examples, the outer portion 109 of the filter 108 may wrap around the top edge of the container 102. To replace the filter 108, the cover 106 is removed from the container 102. Then, the filter 108 can be replaced, and the cover 106 is reinstalled back on the container 102. In some embodiments, the filter 108 may be an integral part of the cover 106. In this case, the filter 108 may have a size that is large enough to cover the opening 104 of the cover 106 and smaller than the open end of the container 102.

During operation, a water treatment device 110 is positioned inside the container 102, for example, at the bottom or lower portion of the container 102. The water treatment device 110 is configured to discharge, distribute, or diffuse an effective amount of ozone into the water stored in the container 102. In some embodiments, one or more water treatment devices 110 may be installed in the container 102. Ozone contains three atoms of oxygen that are different than the two atoms oxygen (O₂) in breathable air (hereafter “air”). Ozone may also be known as “activated oxygen” or O₃. The oxidizing properties of ozone can reduce or eliminate foul taste and odor problems in air or water. Furthermore, ozone is a powerful sterilant that can be used as an effective disinfectant to treat air, water, or other fluids. In some applications, ozone can effectively kill bacteria, viruses, microorganisms, spores, and many other pathogens, while it removes dissolved organic materials by oxidative processes. Ozone has been used to treat and disinfect water supply. The use of ozone can treat and disinfect the water, making it safer for human consumption. In one embodiment, the water treatment device 110 is configured to discharge an air mixture containing an effective amount (e.g., volume percentage) of ozone. In one example, the air mixture may have an ozone concentration up to about 0.3 part per million (ppm).

Ozone is supplied to the water treatment device 110 via a pneumatically sealed hose 112, pipe, air duct, or tube. The hose 112 may pass through an opening on the container 102 or the cover 106. One end of the hose 112 is connected to the water treatment device 110, and another end of the hose 112 is connected to an ozone supply. In some embodiments, the hose 112 may be a flexible tube made of any suitable material.

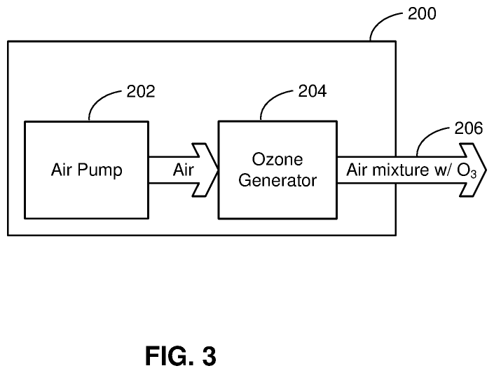

FIG. 3 is a diagram illustrating an exemplary ozone supply 200 according to one embodiment. The ozone supply 200 may be used to supply ozone to the portable water treatment system 100. The ozone supply 200 includes an air pump 202 and an ozone generator 204 for generating ozone (e.g., O₃). In operation, the air pump 202 generates an air stream 206 that is mixed with ozone generated by the ozone generator 204. The air stream may have a pressure greater than atmospheric pressure or any desired pressure. In one example, the air pressure may be up to 2.5 pounds per square inch (psi) for a small container (e.g., 5-gallon container). In another example, the air pressure may be up to 6 psi for a larger container (e.g., 55-gallon container). The ozone-mixed air stream or ozone may be supplied to the water treatment device 110 (see FIGS. 1 and 2) to disinfect the filtered water in the container 102. In one embodiment, when the water treatment device 110 is placed at the bottom or lower portion of the container 102, the ozone distributed by the water treatment device 110 raises up from the bottom to the water surface so as to increase the cleaning and disinfecting effect of the ozone.

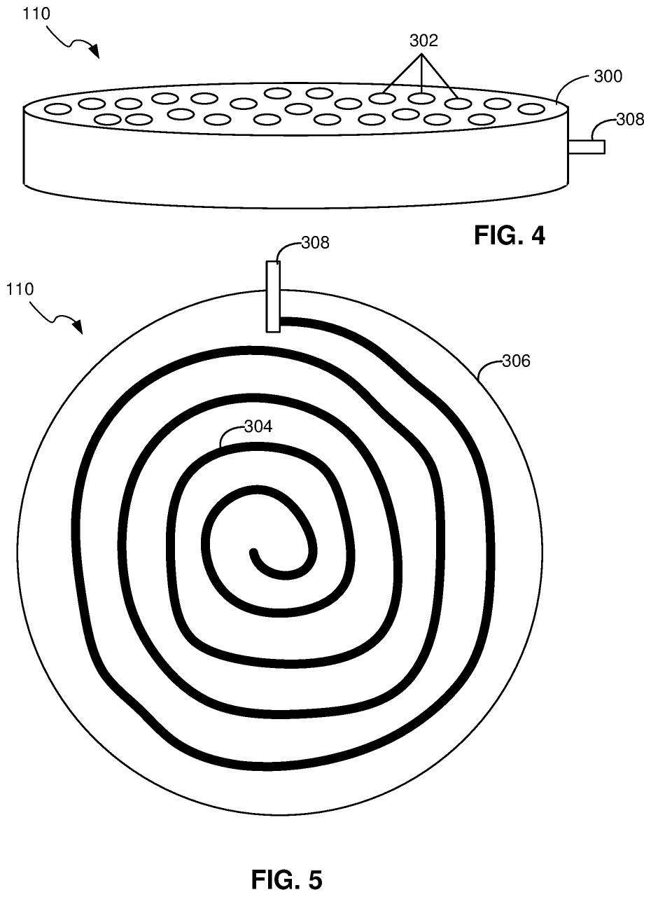

FIG. 4 is a diagram illustrating a perspective view of the water treatment device 110 according to one embodiment. FIG. 5 is a diagram illustrating a top view of the water treatment device 110 of FIG. 4. The water treatment device 110 has a cover 300 and a housing 306. The cover 300 is not shown in the top view of FIG. 5.

The cover 300 of the water treatment device has a plurality of openings 302 that allow ozone or ozone-mixed air to egress or escape from the water treatment device 110 during operation. The water treatment device 110 includes a tortuous porous tube 304 in the housing 306. The porous tube 304 may be connected to the hose 112 (see FIGS. 1 and 2) via an inlet, connector, or coupler 308. The porous tube 304 when extended is substantially longer than the length and/or width of the housing 306. In this particular example, the porous tube 304 is coiled to fit into the housing 306. The housing may have additional openings (not shown), for example, on the side and/or bottom. The openings allow water to enter the water treatment device 110 when it is submerged in water such that the porous tube 304 is submerged in water during operation.

In some embodiments, the porous tube 304 may have other tortuous configurations like a wound shape, helical shape, bend shape, circular shape, rolled shape, spiral shape, and the like. By maximizing the length of the porous tube 304 that can be fitted into the housing 306, a ratio of the surface area of the porous tube 304 to the volume of the housing can be increased. Therefore, the efficiency or rate of ozone diffusion of the water treatment device 110 can be increased. In some embodiments, the water treatment device 110 can provide about 100 liters of ozone-mixed air per minute. In one example, the water treatment device 110 can provide up to 40 LPM (liter per minute) of ozone-mixed air to a small container (e.g., 5-gallon container). In another example, the water treatment device can provide up to about 110 LPM of ozone-mixed air to a large container (e.g., 55-gallon container).

During operation, the porous tube 304 can diffuse an efficient amount of ozone-mixed air bubbles into the water to achieve effective and efficient disinfection of the water using ozone. In some embodiments, the water treatment device 110 may be configured with two or more porous tubes 304.

While the above description contains many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents.

What is claimed is:

1. A portable water treatment system using ozone, comprising:
a collapsible container for holding water;
a removable cover on an open end of the collapsible container, the removable cover having an opening configured to receive the water into the collapsible container;
a filter positioned at the opening of the removable cover and configured to filter the water entering the collapsible container; and
a water treatment device configured to disinfect the water in the collapsible container using ozone, the water treatment device comprising a tortuous porous tube configured to distribute the ozone.

2. The portable water treatment system of claim 1, further comprising an ozone supply configured to supply the ozone to the water treatment device.

3. The portable water treatment system of claim 1, wherein the filter comprises a sheet filter.

4. The portable water treatment system of claim 3, wherein the sheet filter comprises a paper filter or cloth filter.

5. The portable water treatment system of claim 3, wherein the sheet filter has a size configured to cover the entire open end of the collapsible container.

6. The portable water treatment system of claim 3, wherein the sheet filter is configured to wrap around an edge of the open end of the collapsible container.

7. The portable water treatment system of claim 1, wherein the filter is removably secured between the removable cover and the collapsible container.

8. The portable water treatment system of claim 1, wherein the tortuous porous tube is configured in at least one of:
a coiled shape;
a helical shape;
a spiral shape;
a circular shape; or
a wound shape.

9. The portable water treatment system of claim 1, wherein the tortuous porous tube when extended is substantially longer than the water treatment device in a length and/or width direction.
